(19) United States
(12) Patent Application Publication
(10) Pub. No.: US 2026/0349311 A1
(43) Pub. Date: Nov. 5, 2026

(54) MANY TO MANY BROADCASTING WITH IN-SITU OPTIMIZATION USING DISPLACEMENT PHASE MODULATORS

(71) Applicant: SILICON LIGHT MACHINES CORPORATION, San Jose, CA (US)

(72) Inventors: Stephen Hamann, Mountain View, CA (US); Olav Solgaard, Stanford, CA (US); Lars Eng, Los Altos, CA (US); Alexander Payne, Ben Lommond, CA (US); James Hunter, Campbell, CA (US); Yoshimi Hashimoto, Kyoto (JP)

(73) Assignee: SILICON LIGHT MACHINES CORPORATION, San Jose, CA (US)

(21) Appl. No.: 19/564,127

(22) Filed: Mar. 11, 2026

Related U.S. Application Data
(60) Provisional application No. 63/769,894, filed on Mar. 11, 2025.

(51) Int. Cl. G02F 1/313; H04Q 11/00

(52) U.S. Cl. CPC G02F 1/3132; H04Q 11/0001

(57) ABSTRACT

An optical system using displacement phase modulators (DPMs) with in-situ optimization is provided for use in datacom and telecom applications. Generally, the system includes a number of DPMs, each including a plurality of microelectromechanical system-based two-dimensional modulators arranged to form a plurality of pixels, each pixel operable to modulate light incident thereon, an input light source operable to illuminate at least a portion of a first DPM, and an output matrix to receive modulated light reflected from at least one of the DPMs and couple said modulated light to a number of waveguides as output signals. In one embodiment, the system further includes a system controller coupled to the DPMs and operable to receive measurements of the strength of the output signals and update a phase mask applied to at least one of the DPMs to automatically correct or rebalance the output signals. Other embodiments are also disclosed.

### CROSS-REFERENCE TO RELATED APPLICATIONS

This application claims the benefit of priority under 35 U.S.C. 119(e) to U.S. Provisional Patent Application Ser. No. 63/769,894, filed Mar. 11, 2025.

### TECHNICAL FIELD

The present invention relates generally to optical systems, and in particular systems and methods for high-speed switching and routing of optical signals in optical communication and computing systems using displacement phase modulators.

### BACKGROUND

Optical systems are widely used in communication or telecom systems to broadcast or route optical signals from one or more input light sources to one or more output matrixes, and in computing or datacom systems for unitary transformation of optical signals for optical computations. Functionally, these optical systems include a number of optical scanner switches or optical switches to direct light from any number (N) of input light sources to any number (M) of output matrixes, such as waveguides or optical fibers. Conventional optical systems can be designed to support one to many (1×M) or many to many (N×M) broadcasting, and include optical switches implemented using spatial light modulators (SLMs) to modulate and/or direct light from an input to an output by changing an angle at which light is reflected from a reflective surface or mirror in the optical switch.

Currently available SLMs suitable for use in optical switches include liquid-crystal-on-silicon (LCOS) modulators and digital micro-mirror devices (DMDs). LCOS modulators use an electric field to change an orientation of liquid crystal molecules in a liquid crystal layer, thereby changing an angle at which light is reflected from a reflective layer on a silicon substrate. DMDs use an array of tilting microscopic mirrors suspended above a surface of substrate, which are electrostatically deflected toward the surface of the substrate thereby changing an angle at which light is reflected from the microscopic mirrors allowing light to be redirected towards or away from a fixed output. An array of tip-tilt multi-axis scanning mirrors may similarly redirect light but to an arbitrary single selection of the output matrix.

Optical systems using SLMs as optical switches require a precise alignment of the reflective surface relative to the input light source and output matrix. This alignment can be difficult and expensive to initially set up. Another problem with such optical systems is that alignment can vary from individual modulator to modulator in the optical switch, and change over time due to degradation in materials of the input light source, output matrix or reflective surfaces, or even very short periods of time due to changes in the intensity, phase or frequency of incident light.

One solution to the above problems is to visually monitor the input and output light using multiple reference beams with cameras on the input and/or output, and to adjust the alignment output by adjusting the angle of reflection of the reflective surfaces or mirrors. However, this approach requires expensive and bulky cameras, and is too slow to enable in-situ optimization in situations that require on the fly or real time alignment and rebalancing of the optical system.

Additionally, many of the current solutions only enable casting from a single input to single output, while advancing communication and computation technologies including neural networks and optical computing may benefit from more complex input-output relationships by casting from any input to any number of outputs. Finally, systems that utilize a single phase modulating device such as a LCOS SLM may multicast but are typically restricted to a single wavelength while broadband multicasting may be desirable and so a more spectrally robust system is required.

Accordingly, there is a need for a more spectrally robust optical system with high-speed optical switches capable of quickly correcting for any alignment issues and methods of operating the same.

### SUMMARY

An optical system using displacement phase modulators (DPMs) with in-situ optimization is provided for use in datacom and telecom applications. Generally, the system includes a number of DPMs, each including a plurality of microelectromechanical system (MEMS) based two-dimensional (2D) modulators arranged to form a plurality of pixels, each pixel operable to modulate light incident thereon, an input light source operable to illuminate at least a portion of a first DPM, and an output matrix to receive modulated light reflected from at least one of the DPMs and couple said modulated light to a number of waveguides as output signals. The system further includes a number of DPM controllers, each coupled to one of the number of DPMs and operable to apply a phase mask to the DPM, and a system controller coupled to the DPM controllers and operable to receive measurements of the strength of the output signals and operate the DPM controllers to update a phase mask applied to at least one of the DPMs to quickly and automatically correct any alignment issues with reflective surfaces in the DPM and/or rebalance the output signals. In some embodiments, the number of DPMs includes multiple DPMs arranged in series to form a continuous optical path from the first DPM to a last DPM, and the system further includes relay optics between each DPM operable to couple light from a preceding DPM to a next DPM.

Generally, the MEMS-based 2D modulators are microelectromechanical devices that include an electrostatically displaceable actuator suspended above an upper surface on the substrate, the actuator including a tensile layer with an actuator electrode, and a faceplate supported by and separated from the surface of the substrate by the actuator. The faceplate has a light reflective surface facing away from the actuator; the actuator in each of the 2D modulators is operable to displace the faceplate in response to an input voltage signal applied between the actuator electrode and one of the substrate electrodes.

In another aspect enabled by the high-speed of the DPM, the system controller and DPM controllers, a method of operating the optical system to optimize the optical output signal is provided. Generally, the method includes the steps of: illuminating substantially all of the 2D modulators in a first of DPM; applying a phase mask to the plurality of 2D modulators in the first DPM, the phase mask including individually weighted offset voltages to be applied to each of the 2D modulators; applying common input vector to the 2D modulators, the input vector including drive voltages operable to drive the 2D modulators to a fully reflective state; measuring optical characteristics of the optical output signal reflected from the plurality of 2D modulators; determining a difference between the measured output signal and a target output signal; and if the difference between the measured output signal and the target output signal is greater than a predetermined stopping point (e.g. a target power or a local maximum), generating and applying an updated phase mask to the plurality of 2D modulators and repeating previous steps of the method.

Further features and advantages of embodiments of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to a person skilled in the relevant art(s) based on the teachings contained herein.

### BRIEF DESCRIPTION OF THE DRAWINGS

Embodiments of the invention will now be described, by way of example only, with reference to the accompanying schematic drawings in which corresponding reference symbols indicate corresponding parts. Further, the accompanying drawings, which are incorporated herein and form part of the specification, illustrate embodiments of the present invention, and, together with the description, further serve to explain the principles of the invention and to enable a person skilled in the relevant art(s) to make and use the invention.

FIG. 1 is aschematic block diagram illustrating a displacement phase modulator (DPM™) including an array of pixels, each pixel including one or more microelectromechanical systems (MEMS) based two-dimensional (2D) modulators;

FIG. 2 is a perspective view of an embodiment of a single pixel including multiple MEMS-based 2D;

FIGS. 3A and 3B are schematic diagrams illustrating an embodiment of a single MEMS-based 2D modulator for use in the DPM™ of FIG. 1;

FIG. 4 is a schematic block diagram in cross-sectional side view of adjacent 2D modulators illustrating operation in a DPM™;

FIG. 5 is a block diagram illustrating an optical communication or computing system including a DPM™ for high-speed switching and routing of optical signals;

FIGS. 6A to 6C are schematic block diagrams illustrating ray optics of embodiments of a 1×N optical switch, optical broadcast switch and optical multicast switch including a DPM™;

FIGS. 7A to 7C are schematic block diagram illustrating ray optics of various embodiments of an M×N optical broadcast switch using multiple cascaded DPM™;

FIG. 8 is a schematic block diagram illustrating ray optics of an embodiment of an M×N optical system using multiple cascaded DPM™ having optics configured to provide a shallower angle of incidence;

FIG. 9 is a schematic block diagram illustrating ray optics of an embodiment of an optical system using multiple cascaded DPM™ having a zero degree angle of incidence;

FIG. 10 is a schematic optical diagram illustrating an embodiment of a Fresnel cascade relay in an optical communication system including multiple cascaded DPMs™;

FIG. 11 is a schematic block diagram illustrating ray optics for input optics including a lenslet array as a collimator for input optics in an optical system including a DPM™; and

FIG. 12 is a flowchart of a method for optimizing operation of an optical system including multiple cascaded DPM™.

### DETAILED DESCRIPTION

An optical system using high-speed displacement phase modulators capable of automatic, iterative in-situ optimization of broadcast optical signals, and methods of operating the same are described herein with reference to the figures described above.

In the following description, for purposes of explanation, numerous specific details are set forth in order to provide a thorough understanding of the present invention. It will be evident, however, to one skilled in the art that the present invention can be practiced without these specific details. In other instances, well-known structures, and techniques are not shown in detail or are shown in block diagram form in order to avoid unnecessarily obscuring an understanding of this description.

Reference in the description to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment. The term to couple as used herein can include both to directly electrically connect two or more components or elements and to indirectly connect through one or more intervening components.

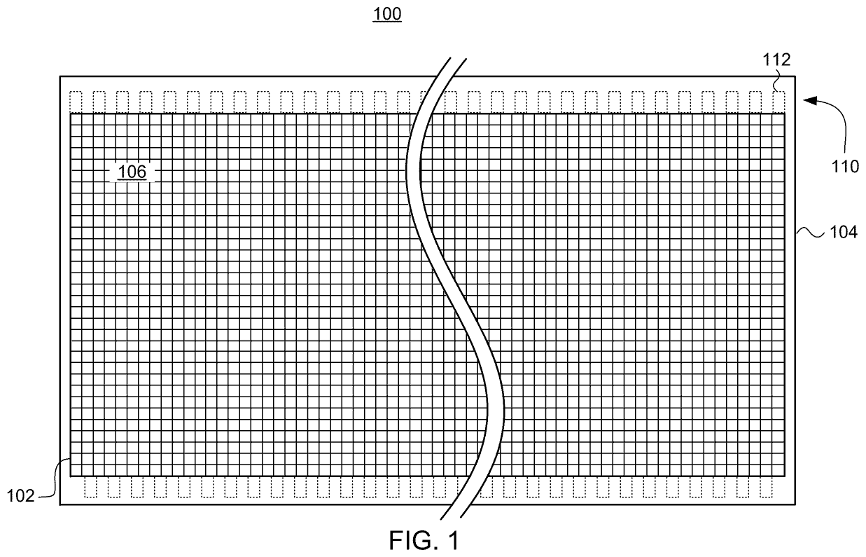

Electro-optic modulators are optical devices in which a signal-controlled optical element, such as a mirror or reflector, is used to modulate the phase, amplitude, or diffraction angle of a beam of light. One example of an electro-optical modulator for phase modulation is known as a displacement phase modulator (DPM™), available from Silicon Light Machines, Inc., of San Jose, California, will now be described with reference to FIGS. 1 to 4. For purposes of clarity, many of the details of fabricating and operating electro-optical modulator, which are widely known and not relevant to the present invention, have been omitted from the following description. The drawings described are only schematic and are non-limiting. In the drawings, the size of some of the elements may be exaggerated and not drawn to scale for illustrative purposes. The dimensions and the relative dimensions may not correspond to actual reductions to practice of the invention.

FIG. 1 is a schematic block diagram of a planar top view of a displacement phase modulator (DPM™ 100) including multiple pixels 102, each including one or more microelectromechanical systems (MEMS) based two-dimensional (2D) modulators (not shown in this figure), and arranged on a surface of a substrate 104 to form an array 106. In the embodiment, shown the array 106 includes 8,192 pixels arranged in columns and rows to form an anamorphic (32×256) array. However, it is noted that the array 106 can include any number of pixels 102 arranged in any regular or anamorphic configuration. For example, in another embodiment the array 106 can include from 104 to 106 pixels 102 arranged to form a square (100×100) or (1000×1000) array.

The DPM 100 further includes a multi-channel, pixel drive circuit or driver 110 having a number of drive channels 112 each coupled to drive one or more of the 2D modulators in one of the pixels 102. The driver 110 can be integrally fabricated directly in or on the same substrate 104 with the array 106, as in the embodiment shown, to form a monolithic MEMS-based DPM™, or can be fabricated on a second substrate or chip and electrically coupled thereto (not shown) using standard wire bonding, flip-chip or through silicon vias techniques.

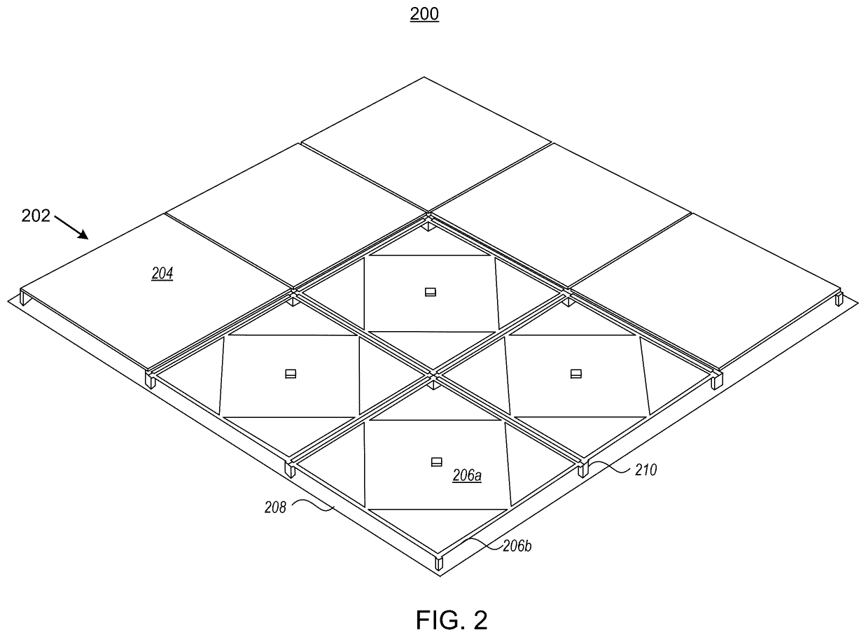

FIG. 2 is a perspective view of an embodiment of a single pixel 200 of a DPM™ including multiple MEMS-based 2D modulators 202 in which faceplates 204 of some of the 2D modulators have been removed. In the embodiment, shown the pixel 200 includes nine individual 2D modulators 202 arranged as a 3×3 square. However, it is noted that the pixel 200 can include any number of individual 2D modulators 202 arranged in any regular on anamorphic configuration. For example, a 2×2 square or a 3×2 rectangle. Referring to FIG. 2, each 2D modulator 202 includes in addition to a faceplate 204 extending over substantially the entire 2D modulator an underlying actuator or actuator layer 206 suspended over a surface on a substrate 208 by posts 210 at corners of the 2D modulator. The actuator layer 206 includes an electrostatically deflectable central piston or plate (CP 206a) and a number of flexures 206b through which the CP is flexibly or movably coupled to the posts 210.

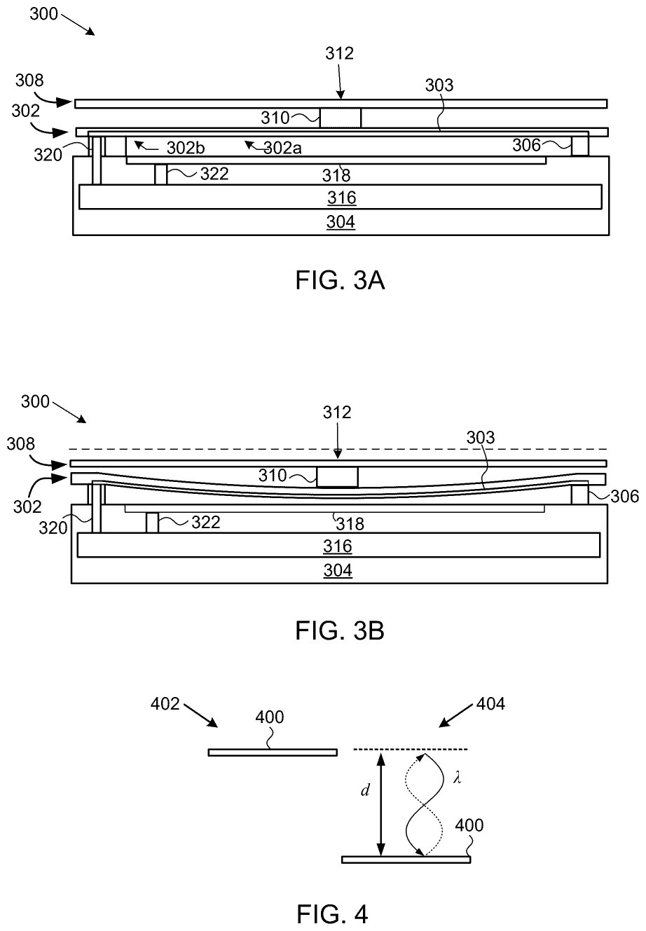

An embodiment of a 2D modulator 300 particularly suitable for use in an array of a MEMS-based DPM™ for phase modulation is shown in FIGS. 3A and 3B. FIGS. 3A and 3B are simplified schematic block diagrams illustrating a cross-sectional side view of the 2D modulator 300 in an undeflected or static state and in a deflected or active state, respectively. For purposes of clarity, many of the details of fabricating and operating MEMS-based 2D modulators, which are widely known and not relevant to the present invention, have been omitted from the following description. Such details are described in greater detail, for example, in commonly assigned U.S. Pat. No. 7,227,687, which is incorporated herein by reference in its entirety.

Referring to FIG. 3A, the 2D modulator 300 includes an actuator layer or actuator 302 suspended over a surface on a substrate 304 by posts 306 at corners of the 2D modulator. The actuator 302 includes a taut structural layer of tensile, silicon nitride (SiN) or tensile amorphous silicon germanium (SiGe) and a layer of conductive material to form an actuator electrode 303. In one embodiment, the actuator 302 includes tensile, amorphous SiGe, which has been implanted with impurities or dopants to form a conductive implanted SiGe layer that also functions as the actuator electrode. Suitable impurities and dopants include Boron (B), Aluminum (Al), Gallium (Ga), Indium (In), Silicon (Si), Gold (Au) Xenon (Xe) Nitrogen (N), and Argon (Ar), ion implanted to a concentration of about from about of about 1E13 atoms/cm³ to about of about 1E18 atoms/cm³.

The actuator 302 includes an electrostatically deflectable central piston or plate (CP 302a) and a number of flexures 302b through which the CP is flexibly or movably coupled to the posts 306. A phase shift element or faceplate 308 extending over substantially the entire 2D modulator is supported above and separated from the CP 302a by a central post 310. In the embodiment shown, the faceplate 308 includes a single light reflective surface 312.

The 2D modulator 300 further includes a driver 316 integrally formed in or on the substrate 304 underlying at least some of the 2D modulators 300, the driver operable to generate a voltage between a common electrode 318 and the actuator electrode 303 to cause displacement of the CP 302a. The actuator electrode 303 is electrically coupled to one of a number drive channels in the driver 316 through a conductor 320 extending through one or more of the posts 306, and to the common electrode 318 through one or more vias 322 and metal layers (not shown in these figures).

FIG. 3B is a simplified schematic diagram illustrating a sectional side view of the 2D Modulator 300 of FIG. 3B in an active or driven state. The 2D Modulator 300 is operable so that electrostatic deflection of the CP 302a causes a coherent light reflected from the light reflective surface 312 of the faceplate 308 to be modulated in phase from that of the incident light and/or light reflected from static 2D modulators.

Materials of the light reflective surface 312 of the faceplate 308 are selected so that the DPM™ is operable to modulate light ranging from deep ultraviolet light (DUV) to near-infrared (NIR) at wavelengths from 150 nm to 3 μm. Suitable reflective materials can include aluminum (Al), gold (Au), silver (Ag) or any other suitably reflective metal. Alternatively, the reflective surfaces can include a multilayer dielectric or Bragg mirror including one or more alternating layers with different optical characteristics or properties, such as reflection, transmission and absorption depending on the wavelengths of the incident light being modulated.

FIG. 4 schematically illustrates displacement (d) of a faceplate 400 of a 2D modulator from a static state 402 to an active state 404 in relation to a wavelength (λ) of an incident light. Generally, the dimensions of the actuator, flexures and a gap between the actuator and surface of the substrate are selected to enable the faceplate 400 to be deflected through a distance (d) equal to at least one half wavelength (λ) of the incident light to enable a 2π modulation. Preferably, the faceplate 400 is deflectable through one or more wavelengths of the incident light to enable both the phase and the amplitude of a reflected light to be modulated independently. More preferably, the faceplate 400 can be displaced by n*λ/2 wavelength, where λ is a particular wavelength of light incident on the DPM™, and n is an integer equal to or greater than 1. Moving the faceplate 400 brings reflected light from the light reflective surfaces of the 2D modulator into constructive or destructive interference with light reflected from a 2D modulator in an adjoining pixel or light reflected from an adjoining 2D modulator in the same pixel, thereby modulating light incident on the DPM™.

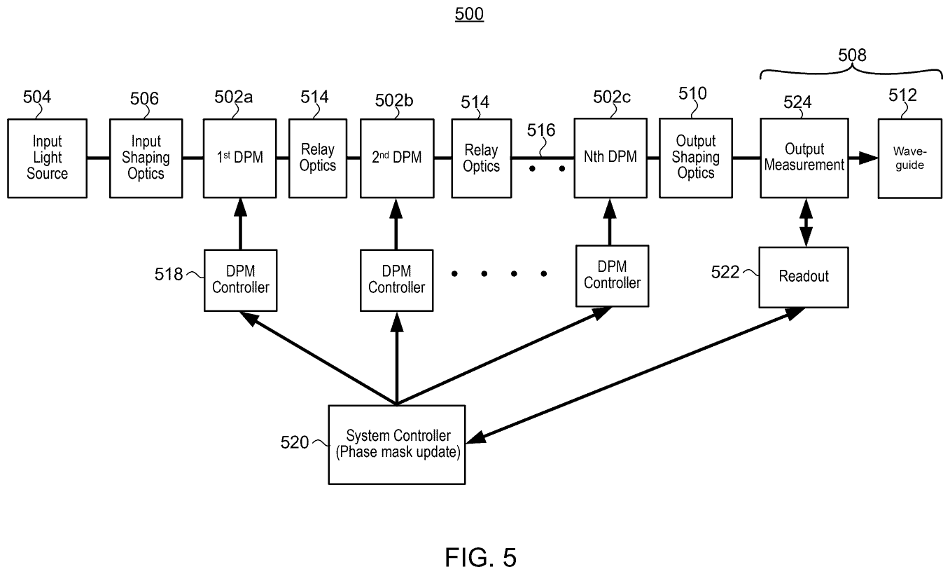

FIG. 5 is a block diagram illustrating an optical communication or computing system including a DPM™ for high-speed switching and routing of optical signals. The optical system 500 includes a number of displacement phase modulators (DPMs 502a, 502b, 502c), each DPM™ including a plurality of 2D modulators (not shown) arranged to form multiple pixels as described above, each pixel operable to modulate light incident thereon. Generally, the optical system 500 includes an input light source 504 operable to illuminate at least a portion of a first of the number of DPMs 502a through input shaping optics 506, and an output matrix 508 operable to receive modulated light reflected from the last in the number of DPMs 502c through output shaping optics 510 and couple the modulated light to a number of waveguides 512 as output signals. Where, as in the embodiment shown, the optical system 500 includes multiple DPMs 502a, 502b, 502c, cascade or arranged in an optical series, the optical system further includes relay optics 514 between each of the DPMs operable to transmit light from one DPM™ to a subsequent DPM™ in an optical path 516 through the optical system.

The input light source 504 can include a number (M) of individual light sources (not shown), such as an input matrix of M optical fibers, or a number (M) of individual lasers or laser diodes, such as VCSELs integrally fabricated on a common substrate to form a photonic array. The input light source 504 may be single wavelength or multispectral.

The input shaping optics 506, described in greater detail below, generally includes a number of optical elements such as lens, lenslet arrays, and fixed diffractive elements, and is operable to illuminate all or a portion of an array in the first DPM™ 502a with light from one or more of a number of individual light sources in the input light source 504. In some embodiments, the input shaping optics 506 are configured and operable to illuminate pixels in a first portion or contiguous areas of the array in the first DPM™ 502a with light from a first number of lasers or optical fibers, and a separate second portion of the array with light from a second number of lasers or optical fibers. It will be understood that because each of the DPMs 502a, 502b, 502c, include an array with plurality of individually addressable pixels the number of individual light sources need not equal the number of separately illuminated portions or areas of the array. Thus in one embodiment where the input light source 504 includes M individual light sources the input shaping optics 506 can be configured and operable separately illuminate pixels in M different portions of the array of the first DPM™ 502a, each with light from a different individual light source. In other embodiments, the input shaping optics 506 can be configured and operable to separately illuminate pixels in a number (N) of different portions of the array of the first DPM™ 502a, where N may be greater or lesser than M. This latter embodiment is particularly useful in many to many broadcasting applications.

The output shaping optics 510 can also include a number of optical elements such as lens, lenslet arrays, and fixed diffractive elements, and is operable to collimate and direct light different portions of an array in the last DPM™ 502c to one or more different output channels, such as waveguides, in the output matrix 508. In one embodiment, the output shaping optics 510 include a microlens or lenslet array operable to collimate and direct light different portions of an array in the last DPM™ 502c to a matrix of one or more optical fibers in the output matrix 508.

Where included the relay optics 514, described in greater detail below, can include a number of optical elements such as lens, lenslet arrays, fixed diffractive elements, and polarizing beam splitters (PBS), and are configured and operable to transmit light from one DPM™ to a subsequent DPM™ in the optical path 516 through the optical system 500. As with the input shaping optics 506, because each of the DPMs 502a, 502b, 502c, include a plurality of individually addressable pixels can be configured and operable separately illuminate pixels in a number (N) of different portions of the array of the subsequent DPM™ 502b or 502c with light from M different portions of the preceding DPM™ 502a or 502b, where N may be equal to, greater than or lesser than M.

In order to enable automatic, in-situ optimization and rebalancing of phase patterns transmitted through the optical system 500, the system further includes a number of DPM controllers 518, a system controller 520, such as a computer, a readout 522, and a number of output measurement devices 524 in the output matrix 508. The output measurement devices 524 can include a camera or a number of photo sensors, such as photodiodes and phototransistors.

Each of the DPM controllers 518 is coupled to one of the DPMs 502a, 502b, 502c, and is operable to supply voltage drive signals to the actuator and substrate electrodes in the 2D modulators to control the deflection of the faceplates 208 in each 2D modulator. In some embodiments, the DPM controllers 518 are configured to individually control or drive each 2D modulator in an array of the DPM™ 502a, 502b, 502c. In other embodiments, the DPM controllers 518 may be configured to drive two or more of the individual 2D modulators in one or more pixels with a same voltage drive signal. Generally, the voltage drive signals supplied to each DPM™ include both a digital data signal and a phase mask. The phase mask includes a number of offset voltages applied to each of the individual 2D modulators, or all of the 2D modulators in one or more pixels to adjust deflection of the faceplates to compensate for variations in a phase shift pattern from the DPM™ due to variations in manufacture of the individual 2D modulators, or variations in illumination caused by misalignment optical elements in the optical path 516 variations in light from the input light source 504 or aging of elements in the optical system 500. The phase mask is calculated in an optimization process using the system controller 520 and is based on measured signals from the output measurement devices 524 coupled to the system controller through the readout 522 as compared to an optimal or target value stored in the system controller. The measured signals generally include information or data on the phase and intensity of each of a number (N) of optical signals received in and output by the output matrix 508. The optimization process can be initiated by a manufacturer at assembly, by a system user when the optical system 500 is installed for a particular application or can be initiated automatically by the system controller 520 at regularly scheduled intervals, when the optical system 500 is not active or when a mismatch between expected and measured optical output signal is detected. The optimization process is described in greater detail below.

The digital data signals applied to each DPM™ 502a, 502b, 502c, through each DPM controller 518 drives individual 2D modulators in one or more pixels to generate or propagate a desired phase pattern or image through the optical system 500. The digital data signals drive the individual 2D modulators in one or more pixels between quiescent and active states to change the phase and/or amplitude of light reflected therefrom. It is noted however that the voltage drive signals may not include digital data signals in all instances, since in some embodiments light from the input light source 504 may include optical signals from matrix of optical fibers or a photonic array.

The high speed with which the DPM™ can be switched from a quiescent to an active state, generally 100 kHz or more, enables an iterative optimization processes to quickly correct for any misalignment issues and rebalance the optical output signals. The speed of the system controller 520 enables several phase mask updates to be calculated or precalculated, with from one to ten thousand phase mask updates calculated within about one to about ten milliseconds (ms) to provide an optimal solution.

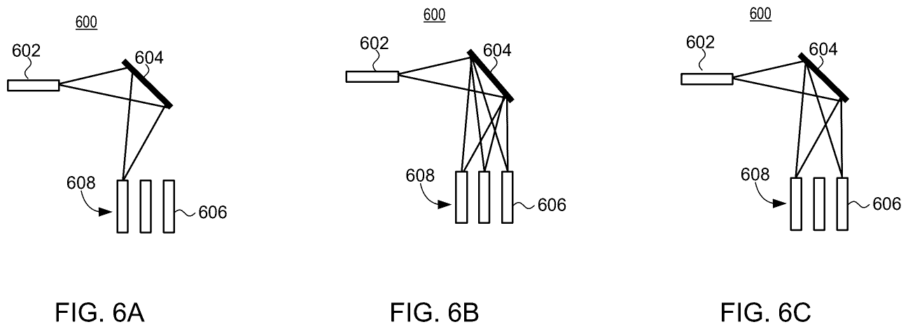

FIGS. 6A to 6C are simplified schematic block diagrams illustrating ray optics of embodiments of a 1×N optical switch, optical broadcast switch and optical multicast switch including a DPM™. For purposes of clarity, many of the details of the optical system 600 described above have been omitted from these figures and the following description.

Referring to FIG. 6A, in a first embodiment it is seen that the optical system 600 can include a single input light source 602 uniformly illuminating substantially the entire surface of an array of a DPM™ 604. The DPM™ 604 is then operated to direct a phase modulated optical output signal to only one waveguide or optical fiber 606 in an output matrix 608 to provide a 1×1 broadcast system by phase modulating the light incident on the DPM™ to direct the output optical signal towards the desired waveguide or optical fiber. It is noted the optical output signal can directed to other waveguides or optical fibers in the output matrix 608 in a time multiplexed manner by applying appropriate digital data signals from a system controller (not shown in this figure) to the DPM™ through a DPM controller (not shown in this figure). It is further noted that, although not shown in this figure, the system further includes output measurement devices and a readout, which can be operated with the system controller to update a phase mask applied to the DPM™ 604 in-situ or on the fly to quickly and automatically optimize or otherwise rebalance the optical output signal. It will be understood that such an optical system 600 is particularly useful to correct any alignment issues when the optical output signal is switched between multiple waveguides or optical fibers in the output matrix 608 or to otherwise rebalance the input-output matrix, such as implementing a multiplication using an optical computation or a new weight for the layer of an optical neural network.

FIG. 6B, illustrate another embodiment in which the DPM™ 604 is then operated to direct the phase modulated optical output signal to all of the number of waveguides or optical fibers 606 in the output matrix 608 simultaneously to provide a 1×N or one to many broadcast system, where N is the number of individual waveguides or optical fibers in the output matrix 608. Again it is noted that, although not shown in this figure, the system further includes a system controller, DPM controller, output measurement devices and a readout, which can be operated to update the phase mask applied to the DPM™ 604 in-situ or on the fly to quickly and automatically optimize or otherwise rebalance the optical output signal.

FIG. 6C, illustrate yet another embodiment of the 1×N or one to many broadcast system in which the DPM™ 604 is operated to direct the phase modulated optical output signal to less than all of the number of waveguides or optical fibers 606 in the output matrix 608. As with the operation of the optical system 600 illustrated in FIG. 6A it is noted that the DPM™ 604 can be operated to direct the optical output signal to other combinations or subsets of waveguides or optical fibers in the output matrix 608 in a time multiplexed manner. It is further noted that, although not shown in this figure, the system further includes a system controller, DPM controller, output measurement devices and a readout, which can be operated to update the phase mask applied to the DPM™ 604 in-situ or on the fly to quickly and automatically optimize or otherwise rebalance the optical output signal.

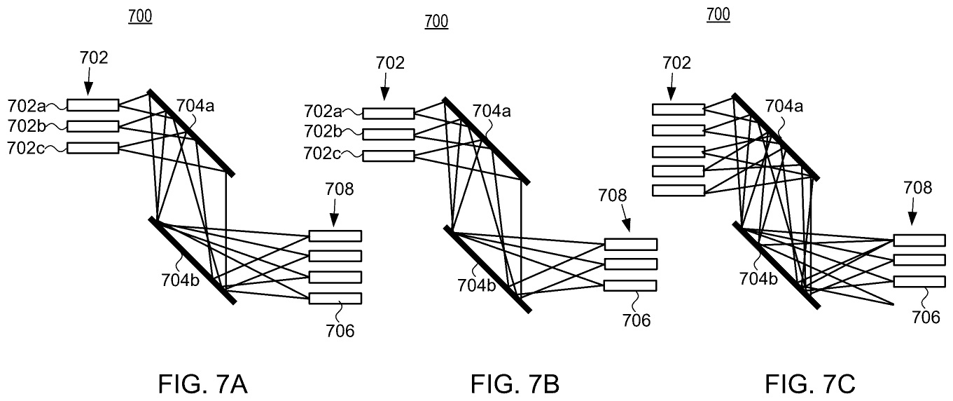

FIGS. 7A to 7C are simplified schematic block diagram illustrating ray optics of various embodiments of an M×N optical broadcast switch using multiple cascaded DPMs™. For purposes of clarity, many of the details of the optical system described above have been omitted from these figures and the following description. In particular it is noted that the input shaping optics, relay optics and output shaping optics have been omitted from these figures.

Referring to FIG. 7A, in a first embodiment the optical system 700 includes include an input light source 702 including a number (M) of individual light sources 702a, 702b, 702c, each illuminating a different portion of an array of a first DPM™ 704a, and a second DPM™ 704b receiving phase modulated light from the first DPM™, the second DPM™ being operable to direct the received light to a number (N) of waveguides or optical fibers 706 in an output matrix 708, to provide a M×N or many to many broadcast system. In the embodiment shown it is noted that while each of the individual light sources 702a, 702b, 702c, illuminate a different portion of the in the first DPM™ array, phase modulated light from substantially all portions of the first DPM™ substantially fills the array of the second DPM™ 704b, and the phase modulated light from substantially the entire array of the second DPM™ is then direct to substantially all N of waveguides or optical fibers 706 in an output matrix 708, thereby transforming the optical input signal to a new optical output signal (Input_{M}*DPM Cascade Transform=Output_{N}). As with the 1×N embodiments described above, it is further that, although not shown in this figure, the system further includes a system controller, a number of DPM controllers, output measurement devices and a readout, which can be operated to update a phase mask applied to each DPM™ 704a, 704b, in-situ or on the fly to quickly and automatically optimize or otherwise rebalance the optical output signals.

FIG. 7B, illustrate another embodiment of an M×N optical broadcast switch in which the number (M) of individual light sources 702a, 702b, 702c, is equal to the number (N) of waveguides or optical fibers 706 in an output matrix 708 (M=N). As with the embodiment of FIG. 7A, light from the individual light sources 702a, 702b, 702c, each illuminate a different portion of the array of the first DPM™ 704a, while the second DPM™ 704b receives phase modulated light from substantially all portions of first DPM™. Phase modulated light from substantially the entire array of the second DPM™ 704b is then direct to substantially all N of the waveguides or optical fibers 706 in an output matrix 708, thereby transforming the optical input signal to a new optical output signal as described above. It is further that, although not shown in this figure, the system further includes a system controller, a number of DPM controllers, output measurement devices and a readout, which can be operated to update a phase mask applied to each DPM™ 704a, 704b, in-situ or on the fly to quickly and automatically optimize or otherwise rebalance the optical output signals.

FIG. 7C, illustrates yet another embodiment of the M×N optical broadcast switch including M individual light sources 702a, 702b, 702c, cascaded first and second DPM™ 704a, 704b, and N waveguides or optical fibers 706 in an output matrix 708, where M is >N. As with the embodiment of FIG. 7A, light from the individual light sources 702a, 702b, 702c, each illuminate a different portion of the array of the first DPM™ 704a. However, unlike in FIG. 7A, phase modulated light from different portions of the first DPM™ illuminates different, overlapping portion of the array in the second DPM™ 704b, and phase modulated light from substantially the entire array of the second DPM™ is then direct to substantially all N of the waveguides or optical fibers 706 in an output matrix 708, thereby transforming the optical input signal to a new optical output signal as described above. Again, although not shown in this figure, the system further includes a system controller, a number of DPM controllers, output measurement devices and a readout, which can be operated to update a phase mask applied to each DPM™ 704a, 704b, and in-situ or on the fly to quickly and automatically optimize or otherwise rebalance the optical output signals.

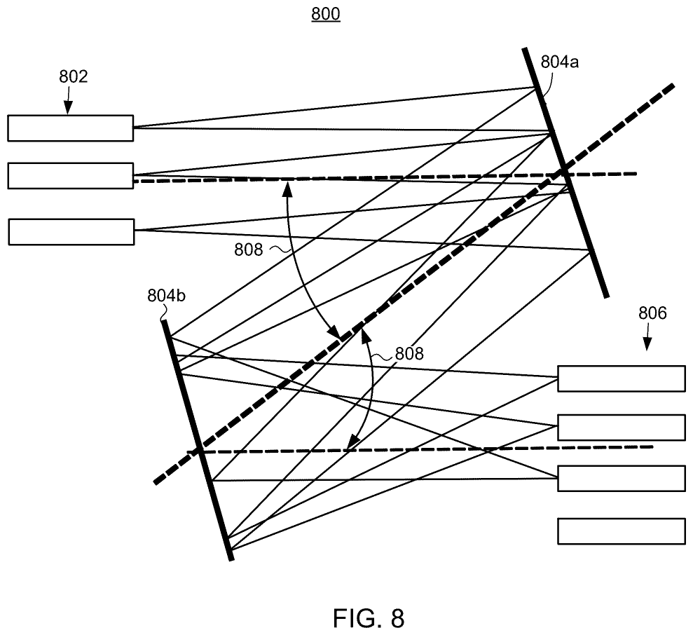

FIG. 8 is a schematic block diagram illustrating ray optics of an embodiment of an M×N optical system 800 having a shallow angle of incidence (AOI) between an input light source 802 and a first DPM™ 804a, a second DPM™ 804b and an output matrix 806, and between the cascaded DPMs™. In the embodiments shown in FIGS. 6 and 7, shows 45° AOI between these components. However, a 45° AOI introduces extreme phase tilt and may move all or some portions of an array in the DPMs™ 804a, 804b, out of a depth of field. FIG. 8 illustrates a shallow angle cascade in which the AOI 808 is substantially less than 45°. An AOI 808 of less than about 15° is preferable, but opto-mechanical considerations, in particular the size and of the input shaping optics, relay optics and output shaping optics, begin to dominate as the AOI is reduced. This restriction may be eased by the use of additional low profile turning mirrors to pick off and redirect the reflected light at effectively a greater angle. Additionally, as the AOI 808 is increased the stroke or distance over which the faceplate in the 2D modulators must be moved between to a quiescent and active state to achieve a desired modulation increases, and larger strokes reduce switching speed and increase the drive voltage required. It has been found that by using multiple cascaded DPM™ 804a, 804b, with an AOI of from about 10° to about 15° and a stroke of

$$\frac{λ}{2 cos AOI} ,$$

λ is the wavelength of the incident light, provide 2π phase shift beyond half wavelength adequate for full phase and amplitude modulation.

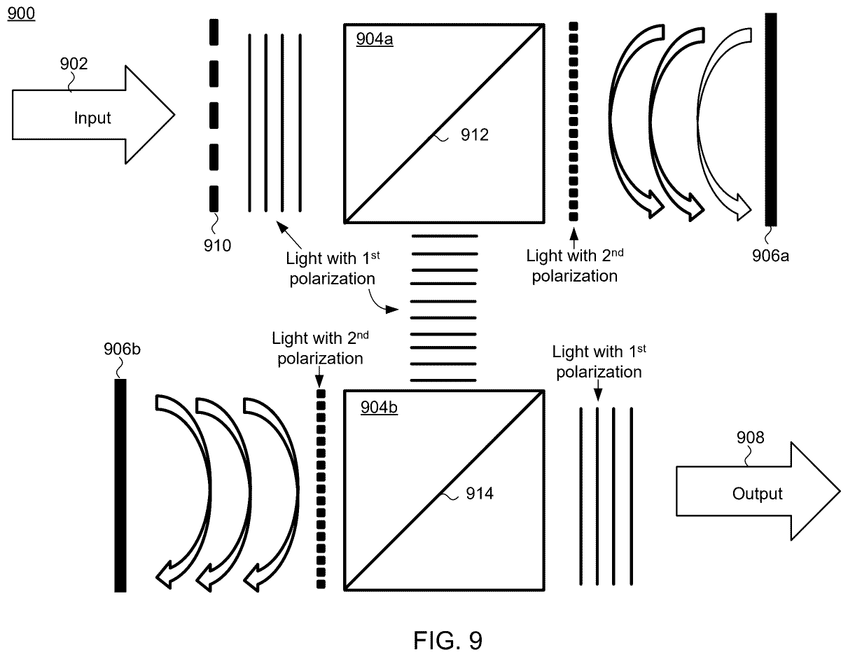

FIG. 9 is a schematic block diagram and ray optics illustrating an embodiment of optics for an optical system using multiple cascaded DPMs™ having a zero degree angle of incidence, and suitable for use as input shaping optics, relay optics and output shaping optics. Referring to FIG. 9, in the embodiment shown the optical system 900 generally includes an input light source 902, a first polarizing beam splitter (PBS 904a), a first DPM™ 906a, a second PBS 904b, a second DPM™ 906b, and an output matrix 908.

In operation, light from input light source 902 passes through a polarizing filter 910 and passes only light having a first polarization (transverse-electric or TE) into the first PBS 904a. A quarter wave plate (QWP 912) in the first PBS 904a rotates the light to a polarization orthogonal to the first and allows only light having a second polarization (transverse-magnetic or TM) to pass through the first PBS to illuminate the first DPM™ 906a. The first DPM™ 906a phase modulates the incident light and reflects the phase modulated light back towards the first PBS 904a with a 0° angle of incidence (AOI). The QWP 912 in the first PBS 904a rotates the phase modulated light reflected from the first DPM™ 906a back to the first or TE polarization, and directs it towards the second PBS 904b. A QWP 914 in the second PBS 904b rotates the phase modulated light from the first PBS 904a to the second or TM polarization, and directs it towards the second DPM™ 906b. The second DPM™ 906b phase modulates the light incident thereon and reflects the phase modulated light back towards the second PBS 904b with a 0° AOI. The QWP 914 in the second PBS 904b rotates the phase modulated light reflected from the second DPM™ 906b, and passes the light, which now has the first or TE polarization, to the output matrix 908.

Although in the embodiment shown the optical system includes only first and second DPMs™ 906a, 906b, and first and second PBS™ 904a, 904b, it will be understood that the optical system could include additional pairs DPMs and PBS.

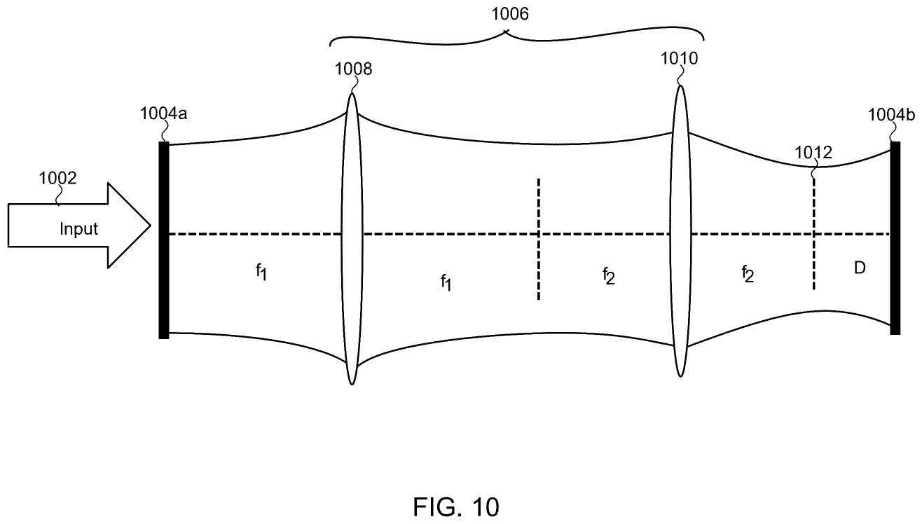

FIG. 10 is a schematic optical diagram illustrating an embodiment of relay optics including a Fresnel cascade relay in an optical communication system including multiple cascaded DPMs™. It is noted that FIG. 10 ‘unfolds’ the optical diagram for convenience, illustrating a input light source 1002, a first DPM™ 1004a, relay optics 1006, and a second DPM™ 1004b in a single plane, while in actual implementation there is an acute angle of incidence (AOI) between the input light source and first DPM™, and between the first and second DPMs™, as shown and described above with reference to FIG. 7.

Referring to 10, in the embodiment shown the relay optics 1006 includes two lens relays or lenses 1008, 1010, placed to create conjugate of a phase pattern or DPM response from the first DPM™ 1004a at distance (indicated by line 1012) of four focal lengths (4 f) from the first DPM™, equal to twice the sum of a focal length of the first lens 1008 (f1) and the focal length of the second lens 1010 (f2). An additional distance D can be included to enable a Fresnel diffraction response. Magnifying relays or lenses 1008, 1010, may be used to constrain light to an active array area of the second DPM™ 1004b after Fresnel divergence. Assuming the relay optics 1006 is a Gaussian relay in which the focal length of the first lens 1008 (f1) is greater than the focal length of the second lens 1010 (f2) a size of conjugate image waist at line 1012 will be reduced, and the magnification (M) can be chosen so that further diffraction for D distance will better fit the active array area of the second DPM™ 1004b.

Finally, although shown as including only two lenses 1008, 1010, adding additional lenses to the relay optics 1006 in multiples of two will allow flexible distances between cascaded elements, such as the cascaded first and second DPMs™.

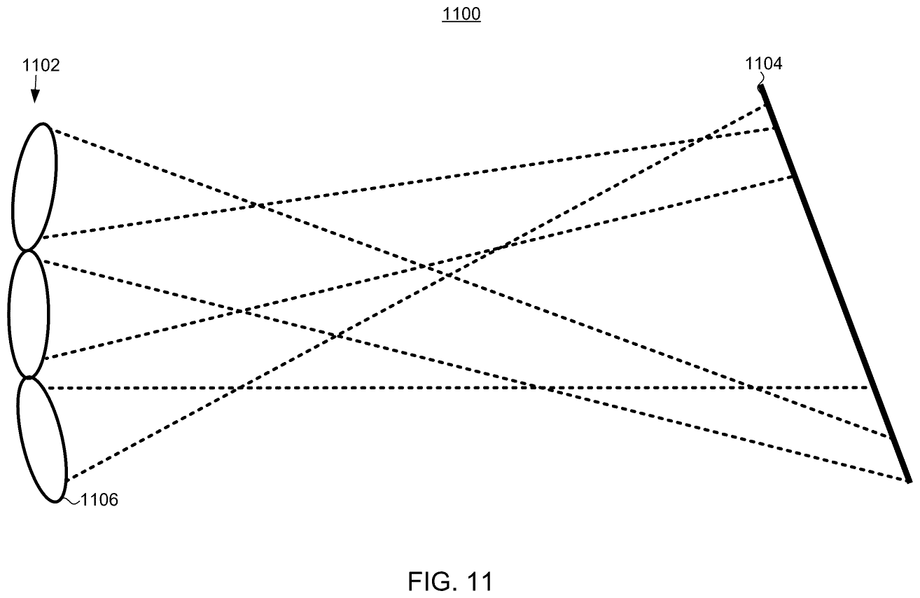

FIG. 11 is a schematic block diagram illustrating ray optics for input optics 1100 including a lenslet array 1102 as a collimator for input optics in an optical system including a DPM™ 1104. Referring to FIG. 11, light from diverging input light sources, such as arrays or matrices of optical fibers, or laser diodes can be collimated using lenslet arrays. Generally, the lenslet array 1102 includes at least one lenslet 1106 for each input light source. The lenslet array 1102 may be arranged to form a planar or non-planar surface, and configured shape the light to illuminate an active array area of the DPM™ 1104. The illumination can be substantially uniform, non-Gaussian shaping light from each light source to illuminate only a portion of the array.

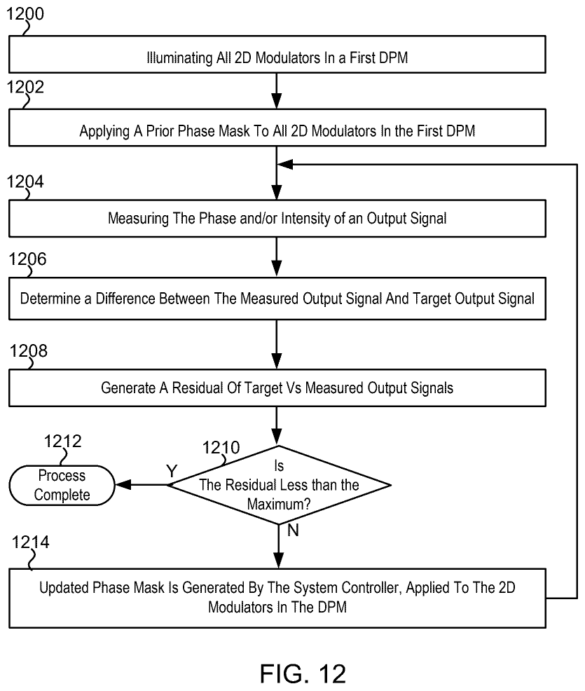

The optimization process of a single DPM will now be described with reference to the flow chart of FIG. 12. Referring to FIG. 12 the process begins by substantially uniformly illuminating all 2D modulators in a first DPM (step 1200). Next, a previously calculated or determined phase mask stored in the DPM controller is applied to all 2D modulators in the DPM (step 1202). The initial state may be random, uniform or some other input depending on the chosen optimization method. The update method will depend on the desired goal, but may include convex optimization techniques such as gradient descent, a non-convex approach such as coordinate descent or some other algorithm for computation or neural network development. The output signal is then measured (step 1204), and a difference in phase and/or intensity of the measured output signal and a predetermined target output signal determined (step 1206). The difference between the measured output signal and target output signal is then squared to generate a residual of target vs measured output signals (step 1208). The residual of target vs measured output signals is compared to a predetermined minimum (step 1210). If the residual of target vs measured output signals is less than the predetermined minimum, the phase mask is not updated and the process is complete (step 1212). If the residual of target vs measured output signals is less than the predetermined minimum, an updated phase mask is generated by the system controller, applied to the 2D modulators in the DPM and the process repeated (step 1214). The updated phase mask can be generated either by calculation as described above or by a reference to a look-up table stored in the system controller. For multiple cascaded DPMs, the process is essentially the same, but the phase mask update must be applied to all DPMs either sequentially or simultaneously. Naively, a sequential update may involve repeating the process described in FIG. 12 such that the results are improved by each DPM in turn while keeping the previously calculated phase masks for the earlier DPMs. However, there are many techniques to apply broadly 2D optimization techniques across the multiple DPMs, such as high rank factorization, or a naturally higher rank approach may be used. The high Speed of the DPM and the system controller allows for an iterative optimization processes to quickly identify any alignment issues or non-desired balancing, determine weights for the updated phase mask, and to rebroadcast any optical data that may have been compromised by misalignment due to conditions or the phase mask update. It has been found that from 1 to 10K iterations or phase mask updates, taking from one to about ten milliseconds (ms) is generally sufficient reduce residual of target vs measured output signals to less than the predetermined minimum.

Thus, embodiments of an optical system using high-speed displacement phase modulators for automatic, iterative in-situ optimization of broadcast optical signals have been described. The optical system has been described with the aid of and reference to functional and schematic block diagrams illustrating implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It is to be understood that the Detailed Description section, and not the Summary and Abstract sections, is intended to be used to interpret the claims. The Summary and Abstract sections can set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

1. An optical system comprising:
a number of displacement phase modulators (DPMs), each including a plurality of two dimensional (2D) modulators arranged to form a plurality of pixels, each pixel operable to modulate light incident thereon;
an input light source operable to illuminate at least a portion of a first DPM of the number of DPMs; and
an output matrix operable to receive modulated light reflected from the number of DPMs and couple said modulated light to a number of waveguides as output signals.

2. The optical system of claim 1, wherein each of the 2D modulators are microelectromechanical systems (MEMS) based electro-optical modulators comprising:
an electrostatically displaceable actuator suspended above a surface of a substrate, the actuator comprising a tensile layer and including an actuator electrode; and
a faceplate supported by and separated from the surface of the substrate by the actuator, the faceplate having a light reflective surface facing away from the actuator,
wherein the actuator in each of the 2D modulators is operable to displace the faceplate in response to a voltage applied between the actuator electrode and a substrate electrode in the substrate underlying the actuator.

3. The optical system of claim 1, further comprising a number of DPM controllers, each DPM controller coupled to one of the number of DPMs and operable to apply a digital data signal and a phase mask to DPM and to control the plurality of 2D modulators in the plurality of pixels to modulate phase, amplitude or both of light incident thereon.

4. The optical system of claim 3, wherein the output matrix comprises sensors operable to directly measure a strength of the output signals, and further comprising a system controller coupled to the number of DPM controllers and operable to receive measurements of the strength of the output signals and update the phase mask applied to at least one of the number of DPMs.

5. The optical system of claim 4, further comprising an output readout through which the system controller is coupled to the sensors, and wherein the system controller is further coupled to the input light source and is operable to receive measurements of the strength of the output signals from the output readout and to control the number of DPM controllers and the input light source to adjust the strength of a number of the output signals to rebalance the output signals.

6. The optical system of claim 5, wherein the system controller is operable to rebalance the output signals by comparing measurements of the strength of the output signals to target strengths, and automatically controlling the number of DPM controllers to update DPM phase masks based on results of the comparison.

7. The optical system of claim 1, wherein the input light source comprises a plurality of light sources, and further comprising input shaping optics operable to collimate light from each of the light sources to illuminate a different portion of the first DPM.

8. The optical system of claim 1, wherein the input light source comprises a plurality of light sources, and further comprising input shaping optics operable to collimate light from all of the plurality of light sources to illuminate all pixels in the first DPM.

9. The optical system of claim 1, wherein the number of DPMs comprise a series of a plurality of DPMs arranged to form a continuous optical path from the first DPM to a last DPM, and further comprising relay optics between each DPM operable to couple light from a preceding DPM to a next DPM.

10. The optical system of claim 9, wherein each waveguide comprises a number of optical fibers, and further comprising output shaping optics operable to couple light from different portions of the last DPM to different waveguides.

11. A method of operating an optical system including a number of displacement phase modulators (DPMs) to optimize an optical output signal therefrom, the method comprising:
illuminating a plurality of two dimensional (2D) electro-optical modulators in a first of DPM;
applying a phase mask to the plurality of 2D modulators in the first DPM, the phase mask comprising individually weighted offset voltages to each of the plurality of 2D modulators;
applying common input vector to the plurality of 2D modulators, the input vector comprising drive voltages operable to drive the plurality of 2D modulators to a fully reflective state;
measuring optical characteristics of the optical output signal reflected from the plurality of 2D modulators;
determining a difference between the measured output signal and a target output signal; and
if the difference between the measured output signal and the target output signal is greater than a predetermined stopping point, generating and applying an updated phase mask to the plurality of 2D modulators and repeating previous steps of the method.

12. The method of claim 11 wherein the optical system further comprises a number of DPM controllers, each DPM controller coupled to one of the number of DPMs, and wherein applying the phase mask, common input vector and the updated phase mask to the plurality of 2D modulators is accomplished using the number of DPM controllers.

13. The method of claim 12 wherein the wherein the optical system further comprises a system controller, and wherein determining the difference between the measured output signal and the target output signal, determining if the is greater than a predetermined stopping point, and generating an updated phase mask is accomplished using the system controller.

14. The method of claim 13 wherein generating the updated phase mask is accomplished by the system controller calculating new weighted offset voltages to each of the plurality of 2D modulators based on the difference between the measured output signal and the target output signal.

15. The method of claim 13 wherein generating the updated phase mask is accomplished by the system controller accessing a lookup table to determine new weighted offset voltages to each of the plurality of 2D modulators based on the difference between the measured output signal and the target output signal.
